(19) United States
(12) Patent Application Publication
(10) Pub. No.: US 2025/0244536 A1
(43) Pub. Date: Jul. 31, 2025

(54) SENSOR UNIT AND METHOD FOR OPERATING A SENSOR UNIT

(71) Applicant: Robert Bosch GmbH, Stuttgart (DE)

(72) Inventors: Patrick Tritschler, Engen (DE); Fabian Zschocke, Ludwigsburg (DE); Peter Degenfeld-Schonburg, Renningen (DE)

(21) Appl. No.: 19/012,513

(22) Filed: Jan. 7, 2025

(30) Foreign Application Priority Data
Jan. 26, 2024 (DE) 10 2024 200 683.1

(51) Int. Cl. G02B 6/293; G02F 1/21

(52) U.S. Cl. CPC G02B 6/29338; G02F 1/212

(57) ABSTRACT

A sensor unit. The sensor unit includes a waveguide, which coupled to a ring resonator by way of a coupling point. The sensor unit includes a Mach-Zehnder interferometer, the input of which is coupled to the waveguide and which includes at least one output. The sensor unit includes a detection unit, which includes at least one detector for detecting states present or output at the at least one output.

### CROSS REFERENCE

The present application claims the benefit under 35 U.S.C. § 119 of German Patent Application No. DE 10 2024 200 683.1 filed on Jan. 26, 2024, which is expressly incorporated herein by reference in its entirety.

### FIELD

The present invention relates to a sensor unit and to a method for operating a sensor unit, to a corresponding control device, and to a corresponding computer program product.

### BACKGROUND INFORMATION

Current optical gyroscopes are either very large in order to ensure good sensitivity or not sensitive enough in chip-integrated applications. Such designs of gyroscopes impede wide availability and universal usability so that very precise measurements are expensive and only available for certain special applications.

### SUMMARY

Present invention provides a sensor unit, a method for operating such a sensor unit, and a control unit using this method, and lastly a corresponding computer program product. Advantageous example embodiments of the present invention are disclosed herein.

According to an example embodiment of the present invention, a sensor unit is provided with the following features:
a waveguide, which is coupled to a ring resonator by way of a coupling point;
a Mach-Zehnder interferometer, the input of which is coupled to the waveguide and which comprises at least one output; and
a detection unit, which comprises at least one detector for detecting states present at the at least one output.

For example, this sensor unit can be constructed to be compact, specifically to be integrated on a substrate or in a chip. In the present case, a coupling point can be understood to be a multimode interferometer, for example, or an arrangement of closely arranged waveguides (for example within a range of 50 nanometers to one millimeter).

The approach provided herein is based on the knowledge that connecting the ring resonator upstream of the Mach-Zehnder interferometer makes it possible to improve the precision in capturing measured values significantly. The approach presented here makes it possible to realize an optical chip-integrated gyroscope which can measure a rotation rate and has high sensitivity. The advantage of the approach presented here can be seen in the fact that this is possible in a compact sensor system which can be constructed in a chip-integrated manner. A ring resonator can be used to generate a quantum state, such as single photons and squeezed light. Utilizing certain quantum states and measurement methods, a robust sensor over a wide temperature range is possible.

Particularly favorable is an example embodiment of the present invention that comprises a second waveguide, which is coupled to the coupling point and/or, by bypassing the ring resonator, to the input of the Mach-Zehnder interferometer and/or, by bypassing the Mach-Zehnder interferometer, to a coupling point between the output and the detector. Such an embodiment advantageously makes it possible to determine physical actions on the Mach-Zehnder interferometer that can then be substantiated by evaluating results of the detector.

Also possible is an embodiment of the present invention in which the output of the Mach-Zehnder interferometer is coupled to at least one further output, wherein the detection unit comprises at least one further detector for detecting states present at the at least one further output. Such an embodiment advantageously makes it possible to evaluate different parameters that may be provided by the Mach-Zehnder interferometer, in the different detectors. For example, the values provided by the different detectors can be linked together and a physical quantity as a measured value can be particularly precisely ascertained therefrom.

According to a further example embodiment of the present invention, the detection unit can be designed to provide a sensor signal by using a detection signal of the first detector and a further detection signal of the at least one further detector, in particular wherein the sensor signal represents a rotation rate and/or rotation of the sensor unit. Such an embodiment makes it possible to very accurately, or precisely, determine the physical quantity with technically relatively simple means.

Also possible is an embodiment of the present invention which furthermore comprises at least one light source and/or one laser light source, which is designed to send light into the waveguide, in particular wherein a further light source and/or a further laser light source is furthermore provided, which is designed to send light into the at least one further waveguide, in particular wherein the light source or the further light source is designed to emit light of different wavelengths. Such an embodiment offers the advantage of a compactly constructed sensor unit on the one hand and, on the other hand, of determining very precise measurement results by using the favorable properties of the light which is output by the light source and/or the further light source.

Particularly favorable is an example embodiment of the present invention in which the light source and/or the laser light source is usable or used as a pumped light source and the further light source and/or the further laser light source is usable or used as a signal light source. Such an embodiment offers the advantage of utilizing the physical properties of the ring resonator efficiently to provide the quantum states, which can then be advantageously used in the Mach-Zehnder interferometer.

For this purpose, according to an example embodiment of the present invention, it is particularly advantageously possible to use a ring resonator designed to generate a quantum state by using three-wave mixing, four-wave mixing, and/or the Kerr effect. A ring resonator of such a design on the one hand can be realized in a technically very simple manner and on the other hand provides quantum states which can be advantageously used in the downstream Mach-Zehnder interferometer.

Also favorable is an embodiment of the present invention in which the waveguide comprises at least second partial waveguides, between which the ring resonator is arranged. Such an embodiment offers the advantage that certain wavelengths can specifically be coupled in and/or out better than others. This furthermore has the advantage that the action of a light source cannot result in interferences and/or effects in downstream optical paths.

For example, in order specifically to be also able to couple light from outside a substrate into a sensor unit and/or to couple light from within a substrate out of the sensor unit, which is constructed in one piece in a separate substrate, it is possible according to a particularly favorable embodiment of the approach proposed here to provide at least one grating coupler or a lateral coupling with tapers for coupling light into the waveguide or for outputting light from the output to at least the detector of the detection unit.

Particularly favorable is an embodiment of the present invention in which at least one phase shifter element is provided for varying a state guided in the waveguide and/or the further waveguide and/or the Mach-Zehnder interferometer, in particular wherein the at least one phase shifter element is controllable depending on a signal of a temperature sensor, and/or wherein the detection unit is designed to infer the rotation rate from the frequency of a measured floating signal. Such an embodiment offers the advantage of being able to operate the sensor unit at particularly favorable operating points as a result of the possibility of phase variation of a quantum state on a conducting unit in the sensor unit, specifically at which operating points the sensor unit can capture a particular physical quantity, such as a rotation rate or a rotation, in a very sensitive manner.

In a further example embodiment of the present invention, a phase shifter is located above or at the ring resonator in order to change the resonance condition in the ring actively. This has the advantage that the quantum states the properties of which can be varied are generated more reliably and that the generation can be controlled. For example, the phase shifters can be designed to be electro-optical with electrodes or to be thermal with heatable layers, such as metal conductors.

According to a further example embodiment of the present invention, at least the waveguide and/or the ring resonator can be formed at least partially as a ridge waveguide with a ridge region and/or as a slot waveguide with a slot region and/or from silicon and/or silicon nitride. Such an embodiment of the approach proposed here makes it possible to generate the individual quantum states significantly more efficiently, which can then also be advantageously coupled from the waveguide into the resonator or vice versa.

Also advantageous is an embodiment of the present invention in which at least one multimode interferometer is adjacent to the ridge region and/or the slot region, in particular wherein the ridge region and/or the slot region is arranged between two multimode interferometers. Using the multimode interferometer(s) makes it possible to realize as lossless a transition as possible between the corresponding slot region or ridge region of the waveguide so that a further increase in the efficiency of such an embodiment of the sensor unit can be achieved.

An advantageous example embodiment of the present invention is a method for operating a sensor unit according to one of the embodiments disclosed herein, wherein the method comprises the following steps:
sending light into at least the waveguide; and
evaluating a reception light received by at least the detector, in order to obtain a sensor signal.

Such an embodiment also allows the aforementioned advantages to be realized in a technically simple and efficient manner.

The present invention also provides a control unit designed to carry out or implement the steps of a variant of a method presented here in corresponding devices. This design variant of the present invention in the form of a control unit can also achieve the underlying object of the present invention quickly and efficiently.

A control unit can be understood here to be an electrical device that processes sensor signals and outputs control signals and/or data signals depending thereon. The control unit can comprise an interface, which can be designed as hardware and/or software. In the case of a hardware design, the interfaces can, for example, be part of a so-called system ASIC, which contains various functions of the control unit. However, it is also possible that the interfaces are separate, integrated circuits or consist at least partially of discrete components. In the case of a software design, the interfaces can be software modules that are, for example, present on a microcontroller in addition to other software modules.

Also advantageous is a computer program product comprising program code that can be stored on a machine-readable carrier, such as a semiconductor memory, a hard disk storage device, or an optical memory, and is used to carry out the method according to one of the above-described embodiments of the present invention when the program product is executed on a computer or a control unit.

The present invention is explained by way of example in more detail below with reference to the figures.

### BRIEF DESCRIPTION OF THE DRAWINGS

FIG. 1A shows a schematic illustration of an exemplary embodiment of a sensor unit, according to the present invention

FIG. 1B shows a schematic illustration of a further exemplary embodiment of a sensor unit, according to the present invention.

FIG. 1C shows an illustration of an exemplary embodiment of the waveguide or the ring resonator of the present invention, which comprises a ridge region.

FIG. 1D shows two illustrations for explaining the possible light guidance in a ridge region of a waveguide or of the ring resonator for use in an exemplary embodiment of the sensor unit of the present invention.

FIG. 1E shows an illustration of an exemplary embodiment of the waveguide or the ring resonator, which comprises a slot region;

FIG. 1F shows two illustrations for explaining the possible light guidance in a slot region of a waveguide or of the ring resonator for use in an exemplary embodiment of the sensor unit of the present invention.

FIG. 2 shows two schematic illustrations of different embodiments or connections of the ring resonator to the waveguide or the different sections of the waveguide, according to the present invention.

FIG. 3 shows a flowchart of an exemplary embodiment of a method of the present invention.

FIG. 4 shows a block diagram of an exemplary embodiment of a control unit, according to the present invention.

### DETAILED DESCRIPTION OF EXAMPLE EMBODIMENTS

In the following description of favorable exemplary embodiments of the present invention, the same or similar reference signs are used for similarly acting elements shown in the various figures, and a repeated description of these elements is dispensed with.

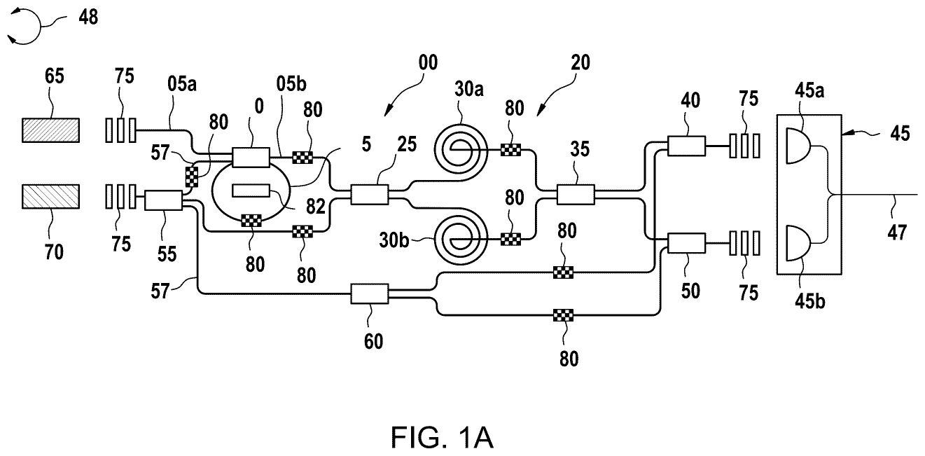

FIG. 1A shows a schematic illustration of an exemplary embodiment of a sensor unit 100. The sensor unit 100 comprises a waveguide 105, which is, for example, divided into two sections 105a and 105b, which are coupled or interlocked to a ring resonator 115 via a coupling point 110. Furthermore, the sensor unit 100 comprises a Mach-Zehnder interferometer 120, which comprises an input 125 (for example in the form of a coupling point or a multimode interferometer) for receiving quantum states or photons from the waveguide 105, and a sensor portion, which is divided into a first sensor section 130a and a second sensor section 130b. For example, the sensor sections 130 may be waveguides of a predetermined (advantageously the same) length, which are however constructed or arranged in the shape of a spiral for space reasons. The sensor sections 130a and 130b can also be nested in each other, wherein the waveguide paths can also overlap. The two sensor sections are coupled and/or interlocked to an output coupling point 140 via a coupling point acting as an output 135 of the Mach-Zehnder interferometer 120 and are designed to output quantum states or photons to a detector 145a of a detector unit 145. Furthermore, a further output coupling point 150 designed to output quantum states or photons to a further detector 145b of the detector unit 145 is coupled and/or interlocked to the output 135 of the Mach-Zehnder interferometer 120. For example, the detector unit 145 is designed to use sensor values of the detector 145a and of the further detector 145b to provide a sensor signal 147 representing, for example, a rotation rate and/or a rotation of the sensor unit 100 about an axis of rotation 148.

In addition, according to the exemplary embodiment shown in FIG. 1A, an input coupling point 155 is provided for the sensor unit 100, which input coupling point is connected via a second waveguide 157 to the coupling point 110 and/or, by bypassing the ring resonator 155, alternatively or additionally, to the input 125 of the Mach-Zehnder interferometer 120 and, additionally or alternatively, via a waveguide coupling point 160 to the output coupling point 140 and/or, additionally or alternatively, via the waveguide coupling point 160 to the further output coupling point 150.

Furthermore, according to the exemplary embodiment shown in FIG. 1A, a light source 165 is now provided, which is configured as a pumped laser light source, for example, and which is designed to send light into the (first) section 105a of the waveguide 105. Alternatively or additionally, a further light source 170 is furthermore provided, which is configured as a signal laser light source, for example, and which is designed to send a further light into the input coupling point 155. Furthermore, it is also possible to use only the light source 170 without the light source 165. In this case, the light source 170 is used as a pumped laser light source and a signal laser light source. This is possible since signal photons of the same wavelength as the pumping source can also be generated in the ring resonator via four-wave mixing.

It is furthermore possible that grating couplers 175 are used to couple light from the light source 165 or the further light source 170 into the sensor unit 100 if this sensor unit 100 is integrated in a common substrate or chip and the light source 165 or the further light source 170 is arranged outside this substrate or the chip. Analogously, corresponding grating couplers 175 can also be used to couple corresponding quantum states or photons from the output coupling point 140 to the detector 145a and/or from the further output coupling point 150 to the further detector 145b, specifically if one or more of the detectors of the detector unit 145 are not integrated in a common substrate with the other components of the sensor unit 100.

It is furthermore also possible to use phase shifters or phase shifting elements 180 at and/or in individual conductor components of the components of the sensor unit 100 and/or in the ring resonator 115, in particular wherein the phase shifting elements 180 are configured to be controlled individually or collectively such that they can control certain phase shifts or delays of states running in the respective conductor components. For this purpose, it is, for example, possible to use a control unit (not shown in FIG. 1A) which can control the individual phase shifting elements 180. Furthermore, a temperature sensor 182 can be realized in the system in order to detect external temperature fluctuations and, for example, to adjust or modify the system with the control unit via the phase shifter(s) 180 and/or also to modify, for example, the reception sensitivity of the detectors 145a and 145b and/or also to correct the sensor signal 147.

FIG. 1B shows a schematic illustration of a further exemplary embodiment of a sensor unit 100. The exemplary embodiment of the sensor unit shown in FIG. 1B is constructed analogously to the sensor unit 100 shown in FIG. 1A, but with the difference that a slightly modified structure is used in the region of the coupling point 110 or of the waveguide 105 (here, for example, the two partial waveguides 105a and 105b) and the ring resonator 115. Specifically, it is possible here to use, for the waveguide 105 or the ring resonator 115, a waveguide structure that is manufactured at least partially as a ridge waveguide, a slot waveguide, or from a particular material in order to realize particularly good coupling properties or efficiency properties of both waveguides.

FIG. 1C shows an illustration of an exemplary embodiment of the waveguide 105 or the ring resonator 115, which comprises a ridge region 185. This ridge region 185 can be formed, for example, by a portion of the waveguide 105 or of the ring resonator 115, in which portion the waveguide 105 or the ring resonator 115 has a reduced cross-section in comparison to other regions of this waveguide or this ring resonator. For example, the ridge region 185 can be surrounded by a specific three-wave mixing material, such as lithium niobate, or also by a four-wave mixing material, such as silicon or silicon nitride. It is also possible that the waveguide 105 or the ring resonator 115 has a rectangular or square shape in the ridge region 185 in order to allow the light guided in this ridge region to couple as efficiently as possible to one or more external components.

FIG. 1D shows two illustrations for explaining the possible light guidance in a ridge region 185 of a waveguide 105 or of the ring resonator 115 for use in an exemplary embodiment of the sensor unit 100. Both the left and the right illustration show a cross-section through the waveguide 105 or the ring resonator 115 in the ridge region 185. The left illustration of FIG. 1D shows a lateral evanescent field when a TE mode is coupled into the waveguide 105 or the ring resonator 115 and passes the ridge region 185, whereas the right illustration of FIG. 1D shows a lateral evanescent field when a TM mode is coupled into the waveguide 105 or the ring resonator 115 and passes the ridge region 185.

According to this exemplary embodiment, the optical waveguide 105 is realized as a ridge waveguide with the ridge region 185 in which the light is guided, as shown in the subfigures of FIG. 1D for the TE and TM modes, the cross-section is greatly reduced so that a large proportion of the light protrudes at the sides of the waveguide and thus forms a large, evanescent field. A material for three-wave mixing can then be placed over the waveguide so that the evanescent field penetrates into the material at the waveguide sides. If the intensity of the evanescent field is strong enough, the quantum states, which are in part coupled into the waveguide 105, as shown schematically in FIG. 1C, are produced in the material for three-wave mixing.

FIG. 1E shows an illustration of an exemplary embodiment of the waveguide 105 or the ring resonator 115, which comprises a slot region 190. In this slot region 190, the waveguide 105 or the ring resonator 115 has a slot 192 or an opening. In addition, in the protection region 190, the waveguide 105 or the ring resonator 115 can also comprise or be manufactured from a specific three-wave mixing material as described above. Optionally, the slot region 190 may also be adjacent to a multimode interferometer 195 or be arranged between two multimode interferometers 195a and 195b.

FIG. 1F shows two illustrations for explaining the possible light guidance in a slot region 190 of a waveguide 105 or of the ring resonator 115 for use in an exemplary embodiment of the sensor unit 100. Both the left and the right illustration show a cross-section through the waveguide 105 or the ring resonator 115 in the slot region 185. The left illustration of FIG. 1F shows high light intensity as a field in the slot 192 when a TE mode is coupled into the waveguide 105 or the ring resonator 115 and passes the slot region 190, whereas the right illustration of FIG. 1F shows high light intensity as a field outside the slot 192 when a TM mode is coupled into the waveguide 105 or the ring resonator 115 and passes the slot region 190.

In optical waveguide 105, in which the light according to this exemplary embodiment is guided, the slot waveguide is realized with a slot region 190, as shown in FIG. 1E and the subfigures of FIG. 1F for the TE and TM modes. The largest field fraction is located between the waveguide ridges with very high intensity. As in the aforementioned exemplary embodiment, by using the ridge region, the material for three-wave mixing can now also be placed over the waveguide 105 and thus also within the slot 192. The light interacts with the three-wave mixing material in the slot 192, and the quantum states are produced therein.

Optionally, the transition of the optical waveguide 105 to the slot waveguide or the slot region 190 may be provided with multimode interferometers 195 in order to realize a lossless transition. Since the states are already produced in the slot 192, the advantages over the first case, i.e., use of the ridge region 185, are that a lower pumping intensity is sufficient and that a higher proportion of the produced quantum states is coupled into the waveguide 105.

The optical waveguide 105 may also be manufactured directly from the material for three-wave mixing. This is more complex in terms of processing but makes it possible to generate the quantum states significantly more efficiently. Any waveguide shape may be used here. Ribbed waveguides could be used to minimize losses.

By using one of the aforementioned possibilities, the sensor unit 100 shown in FIG. 1B can now be used. For this purpose, light from a laser source can either be generated directly on an optical chip or be coupled thereinto via lateral coupling. In the case of the further possibility, the laser can be positioned directly above the grating coupler and can be guided via a tapered structure from the grating coupler into a waveguide, which usually consists of silicon (SI) or silicon nitride (SiN). The laser corresponds to a pumped laser, for example. For example, the laser light is guided into a region in which light squeezed via three-wave mixing can be generated. This region can be a straight waveguide or a resonator structure in a further embodiment. Three-wave mixing can be realized here. This can be realized via the aforementioned possibilities, which implement the ridge region, the slot region, and/or the implementation of the waveguide or of the ring resonator from or with the material for three-wave mixing.

The three-wave mixing material can be realized using lithium niobate or, preferably, periodically poled lithium niobate (PPLN) or any other material with high second-order susceptibility. Due to the satisfied phase condition, which can be adjusted during manufacture, PPLN has a significantly higher conversion efficiency than lithium niobate. Both cases are realized in a straight waveguide 105 in one exemplary embodiment and in a resonator or ring resonator 115 in a further exemplary embodiment. This resonator consists, for example, of a ring into which the light can be coupled via waveguide coupling or via multimode interferometers. The light circulates in the ring, and a significantly higher intensity of the light is produced. The advantage of using a resonator is that less pumping power is needed to realize three-wave mixing. The produced quantum states can then be coupled out of the ring again and be used for the downstream sensor region. In addition, a certain proportion of the pumped light is, for example, forwarded, which may optionally be filtered out.

According to this exemplary embodiment, the quantum state is then guided to an input of a Mach-Zehnder interferometer 120. This interferometer consists, for example, of two inputs, which lead to a beam splitter with two outputs, which is, for example, adjoined by the sensor region and which in turn, for example, leads to a further beam splitter with two outputs. The beam splitters are realized by multimode interferometers, for example.

In addition, a second laser with the wavelength of the quantum state, which is hereinafter called a signal laser or simply a vacuum state, can, for example, enter the other input. In a further exemplary embodiment, two squeezed or coherently squeezed states can also be generated by one or two ring resonators and can each be guided to an input. It is thus possible with the system, for example, to realize a variation in that a quantum state and the pumped laser enter both inputs of the Mach-Zehnder interferometer. If the pumped laser is used in one or both inputs, the advantage of a greater intensity in the Mach-Zehnder interferometer exists.

For example, the two states then interfere at the first beam splitter of the Mach-Zehnder interferometer, are entangled with each other, and enter the sensor region. In this sensor region, the Sagnac effect acts on the entangled state. As a result, a phase shift acts depending on an applied rotation rate. The state subsequently impinges on the second beam splitter and, depending on the phase shift, the entangled state disentangles or does not. This can, for example, subsequently be measured with different measurement methods. For example, using product detection. This is based on homodyne detection. For example, the signal laser is combined with the output signal into a beam splitter and the resulting interference is measured by one or two detectors. In the latter case, the homodyne detection is a balanced homodyne detection, which offers the advantage of low measurement noise. For example, the phase of the signal laser can be varied by means of one or more phase shifters in order to optimize detection. For example, if homodyne detection is carried out at both Mach-Zehnder interferometer outputs, product detection can be realized. In a further exemplary embodiment, an intensity difference measurement is carried out. For example, the output signals are each measured directly by a detector, and the results are subtracted from each other. In further exemplary embodiments, a coincidence measurement or a parity measurement can also be realized with the aforementioned setups. For all variants, the detectors can be manufactured to be directly integrated or the signal is coupled out via grating couplers or lateral couplers and is measured outside the chip. The entire setup is shown in FIG. 1B, as noted above. By way of example, the two lasers whose light is coupled into a chip via grating couplers are shown. This light initially enters the region for generating three-wave mixing. FIG. 1B shows the generation region as a ring resonator. From there, the light subsequently reaches the first multimode interferometer of the Mach-Zehnder interferometer, for example. Adjoined thereto is the sensor region, which is realized by long waveguides, for example. The waveguides are subsequently guided back to a multimode interferometer, whose outputs lead to the detectors via grating couplers. The path of the signal laser is used to pump the ring resonator, as a signal for a Mach-Zehnder interferometer input and for homodyne detection. It is noted that any of these uses may also be omitted. For example, it is possible to use only one vacuum state for a Mach-Zehnder input or any number of phase shifters in the lowest waveguide path and/or the sensor region, or the order and number of multimode interferometers used in this path can be modified so that the first interferometers already have four outputs.

In a further exemplary embodiment, the entire Mach-Zehnder interferometer can be manufactured such that three-wave mixing is generated in the interferometer region and an SU11 Mach-Zehnder interferometer is thus realized. This has the advantage that further quantum states can be generated across the entire sensor region and losses can thus be compensated. This can achieve higher or very high sensitivity.

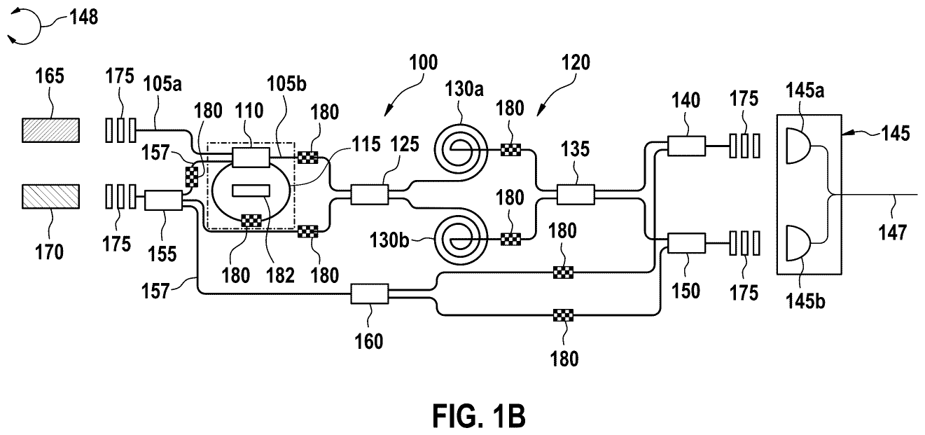

FIG. 2 shows two schematic illustrations of different embodiments or connections of the ring resonator 115 to the waveguide 105 or to the different sections 105a or 105b of the waveguide 105. The left illustration of FIG. 2 shows the arrangement or interlocking of the ring resonator 115 via the coupling point 110 to the two sections 105a and 105b of the waveguide 105. The right illustration of FIG. 2 shows an alternative arrangement of the ring resonator 115 between the first section 105a and the second section 105b of the waveguide 105. An auxiliary coupling point 200 is used, which is arranged oppositely to the coupling point 110, for example halfway along the length of the ring resonator 115, and which is designed to output states running in the ring resonator 115.

By way of example, an architecture in which a quantum state is, for example, generated via four-wave mixing in a ring resonator 115 is thus presented. For example, a ring resonator structure and two lasers as light sources 165 and 170 can be used for this purpose. In this case, one laser corresponds to the pumped laser and the other corresponds to the signal laser. The ring resonator 115 is pumped with the pumped laser. For example, the ring resonator structure is designed to have such a geometry that the resonator condition is satisfied for certain wavelengths. For example, four-wave mixing then produces, in the resonator 115, squeezed or coherently squeezed photons of the wavelength of the signal laser and of other wavelengths for which the resonator condition applies. Subsequently, the generated light is guided at the wavelength of the signal laser into the input 125 of a Mach-Zehnder interferometer 125, which includes a sensor region 130. There, it can interfere with the light of the signal laser. According to the Sagnac effect, a phase shift occurs, which results in a particular interference pattern according to a particular detection method and can thereby be measured.

For example, light from two laser sources of different wavelengths is thus either generated directly on an optical chip or coupled thereinto via grating coupler structures 175, for example. In the case of the second possibility, the laser can be positioned directly above the grating coupler 175 and can be guided from the grating coupler 175 via a tapered structure into a waveguide 105. In this case, one laser corresponds to a pumped laser and the other is a signal laser. Both lasers (or, as a second embodiment, only the pumped laser) are subsequently coupled into the ring resonator 115 via multimode interferometers as the coupling point 110, for example. Depending on whether only the pumped laser or both are coupled in, either squeezed or coherently squeezed photons are produced, for example on the basis of four-wave mixing, which are further described as a quantum state. These photons are coupled out either via the multimode interferometer used for incoupling, i.e., the coupling point 110, or via a different multimode interferometer as an (auxiliary) coupling point 200. In this case, outcoupling can be designed such that only the signal wavelength couples out at the desired outcoupling point 110 or 200. This is shown schematically in FIG. 2. A ring resonator with different incoupling or outcoupling is shown in each case. Once with two inputs and outputs (left illustration of FIG. 2) and once with three (right illustration of FIG. 2). The light is coupled into the ring resonator 115 via the upper left input, or the first section 105a of the waveguide 105. The coupling points 110 and 200 can be designed to outcouple certain wavelengths better than others. For example, in the right illustration of FIG. 2, the coupling points 110 and 200 can be designed such that only the quantum state is coupled out at the lower left output, for example. This has the advantage that no interferences or effects on the basis of the pumped laser can occur in the further path.

The quantum state thus obtained is then guided to an input of a Mach-Zehnder interferometer 120. This interferometer consists of two inputs, which lead to a beam splitter as input 125 or with two outputs, which is adjoined by the sensor region 130 with the two sensor subregions 130a and 130b and which in turn leads to a further beam splitter as output 135 with two output terminals. The beam splitters or the input 125 and the output 135 are realized, for example, by multimode interferometers.

The signal laser, or a light signal supplied by the signal laser via the input coupling point 155, or simply a vacuum state, can enter the other input of the input 125 of the Mach-Zehnder interferometer 120. In a further embodiment, two squeezed or coherently squeezed states can also be generated by one or two ring resonators 115 and can each be guided to an input terminal of the input 125 of the Mach-Zehnder interferometer 120.

At the first beam splitter of the Mach-Zehnder interferometer 120, which is referred to here as input 125, the two quantum states then interfere, are entangled with each other, and enter the sensor region 130. In this sensor region, the Sagnac effect acts on the entangled state. As a result, a phase shift acts depending on an applied rotation rate. The state subsequently impinges on the second beam splitter, which is referred to here as output 135, and, depending on the phase shift, the entangled state disentangles or does not. This can subsequently be measured with different measurement methods in one or more detectors of the detector unit 145, for example using product detection. This is based on homodyne detection. Here, the signal laser is combined with the output signal of the Mach-Zehnder interferometer 120 into a beam splitter as an output coupling point 140 or as a further output coupling point 150, and the resulting interference is measured by one or two detectors 145a or 145b. In the latter case, the homodyne detection is a balanced homodyne detection, which offers the advantage of low measurement noise. The phase of the signal laser can be varied by means of phase shifters 180 in order to optimize detection. If homodyne detection is carried out at both Mach-Zehnder interferometer outputs or at the output 135, product detection can be realized. In a further exemplary embodiment, an intensity difference measurement is carried out, for example. The output signals are each measured directly by a detector, and the results are subtracted from each other. In further exemplary embodiments of the approach presented here, a coincidence measurement or a parity measurement can also be realized with the aforementioned setups. For all variants, the detectors 145a or 145b can be manufactured to be integrated directly on a substrate with the further components or the signal is coupled out via grating couplers 175 and measured outside the chip.

If squeezed photons are used as quantum states, the light from the paths 130a and 130b interfere with each other at the coupling point 135 and an intensity difference measurement can, for example, be carried out in order to detect the sensor signal. The squeezed light ensures that the noise in the system decreases and that a higher measurement resolution thus becomes possible.

In summary, it should be noted that FIG. 1 shows a setup of the approach presented here according to an exemplary embodiment. The two lasers whose light is coupled into a chip via grating couplers 175 are shown. This light initially enters a ring resonator 115 and subsequently reaches the first multimode interferometer 125 of the Mach-Zehnder interferometer 120. Adjoined thereto is the sensor region 130, which is realized by long waveguides. The waveguides are subsequently guided back to a multimode interferometer as output 135, whose outputs lead to the detectors 145a or 145b via grating couplers 175. The path of the signal laser is used to pump the ring resonator 115, as a signal for a Mach-Zehnder interferometer input 125 and for homodyne detection. It should be noted that any of these uses may also be omitted. For example, it is possible to use only one vacuum state for a Mach-Zehnder interferometer input 125 or any number of phase shifters 180 in the lowest waveguide path and/or the sensor region 180, or the order and number of multimode interferometers 120 used in this path can be modified so that the first interferometers already have four outputs.

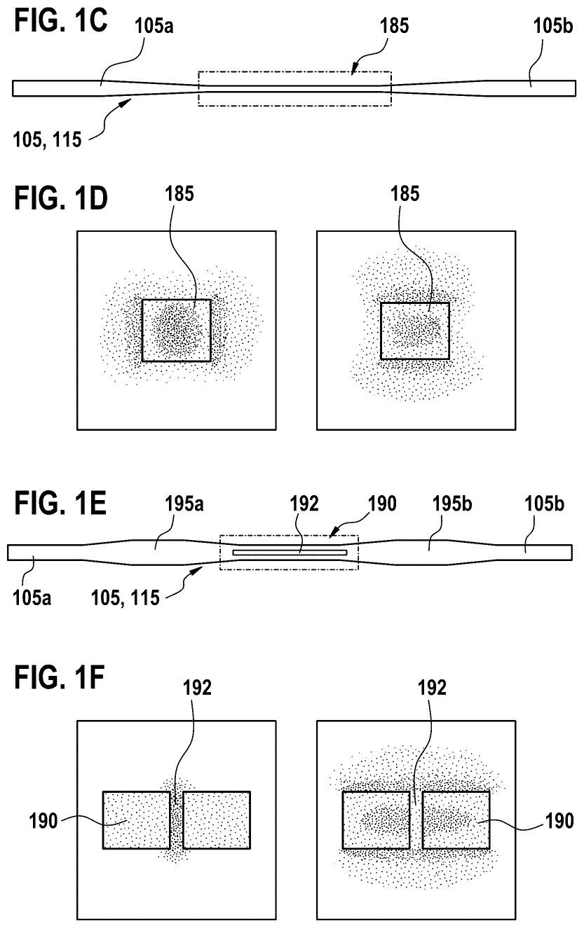

FIG. 3 shows a flowchart of an exemplary embodiment of a method 300 for operating a variant of a sensor unit presented here, wherein the method 300 comprises a step 310 of illuminating at least the waveguide with light and a step 320 of evaluating a reception light received by at least the detector, in order to obtain a sensor signal. In this case, the illumination and/or detection can take place either continuously or at certain points in time.

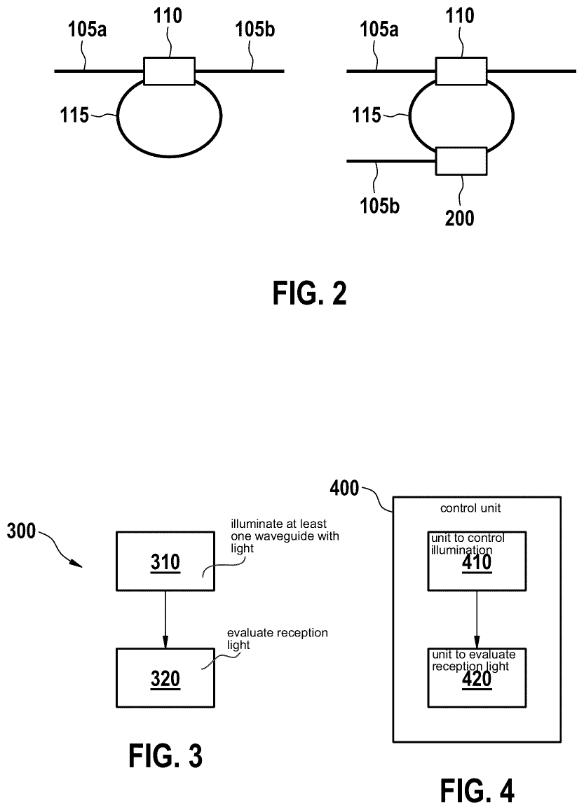

FIG. 4 shows a block diagram of an exemplary embodiment of a control unit 400 for performing a variant of the method 300 for operating a variant of a sensor unit presented here, wherein the control unit comprises a unit 410 for controlling an illumination of at least the waveguide with light and a unit 420 for evaluating a reception light received by at least the detector, in order to obtain a sensor signal.

The exemplary embodiments described and shown in the figures are selected only by way of example. Different exemplary embodiments may be combined with one another in their entirety or with respect to individual features. One exemplary embodiment may also be supplemented by features of a further exemplary embodiment.

The method steps presented here may furthermore be repeated and performed in a different order than that described.

If an exemplary embodiment includes an “and/or” conjunction between a first feature and a second feature, this is to be read such that the exemplary embodiment according to one embodiment comprises both the first feature and the second feature and according to a further embodiment comprises either only the first feature or only the second feature.

What is claimed is:

1. A sensor unit, comprising:
a waveguide coupled to a ring resonator via a coupling point;
a Mach-Zehnder interferometer, an input of the Mach-Zehnder interferometer being coupled to the waveguide, the Mach-Zehnder interferometer further including at least one output; and
a detection unit, which includes at least one detector configured to detect states present or output at the at least one output.

2. The sensor unit according to claim 1, further comprising a second waveguide: which is coupled: (i) to the coupling point, and/or (ii) by bypassing the ring resonator, to the input of the Mach-Zehnder interferometer, and/or (iii) by bypassing the Mach-Zehnder interferometer, to a coupling point between the output and the detector.

3. The sensor unit according to claim 1, wherein the output of the Mach-Zehnder interferometer is coupled to at least one further output, wherein the detection unit includes at least one further detector configured to detect states present at the at least one further output, in which the detection unit is configured to provide a sensor signal by using a detection signal of the first detector and a further detection signal of the at least one further detector, wherein the sensor signal represents a rotation rate and/or rotation of the sensor unit.

4. The sensor unit according to claim 3, further comprising at least one light source and/or one laser light source, which is configured to send light into the waveguide, wherein a further light source and/or a further laser light source is furthermore provided, which is configured to send light into at least one further waveguide, wherein the light source or the further light source is configured to emit light of different wavelengths, in which the light source and/or the laser light source is usable or used as a pumped light source and the further light source and/or the further laser light source is usable or used as a signal light source and/or in which the light source is usable or used as a pumped light source and a signal light source.

5. The sensor unit according to claim 1, wherein the ring resonator is configured to generate a quantum state by using three-wave mixing and/or four-wave mixing, and/or a Kerr effect.

6. The sensor unit according to claim 1, wherein the waveguide includes at least second partial waveguides, between which the ring resonator is arranged.

7. The sensor unit according to claim 1, further comprising at least one grating coupler configured to couple light into the waveguide or to output light from the output to at least the detector of the detection unit.

8. The sensor unit according to claim 2, further comprising:
at least one phase shifter element configured to: (i) vary a state guided in the waveguide, and/or the second waveguide and/or the Mach-Zehnder interferometer, and/or (ii) change a resonance condition of the ring resonator;
wherein the at least one phase shifter element is controllable depending on a signal of a temperature sensor, and/or the detection unit is configured to infer a rotation rate of the sensor unit from a frequency of a measured floating signal.

9. The sensor unit according to claim 1, wherein at least the waveguide and/or the ring resonator is at least partially formed: (i) as a ridge waveguide with a ridge region, and/or (ii) as a slot waveguide with a slot region, and/or (iii) from silicon and/or silicon nitride.

10. The sensor unit according to claim 9, wherein at least one multimode interferometer is adjacent to the ridge region and/or the slot region, or wherein the ridge region and/or the slot region is arranged between two multimode interferometers.

11. A method for operating a sensor unit, the sensor unit including:
a waveguide coupled to a ring resonator via a coupling point,
a Mach-Zehnder interferometer, an input of the Mach-Zehnder interferometer being coupled to the waveguide, the Mach-Zehnder interferometer further including at least one output, and
a detection unit, which includes at least one detector configured to detect states present or output at the at least one output;
the method comprising the following steps:
sending light into at least the waveguide; and
evaluating a reception light received by at least the detector, to obtain a sensor signal.

12. The method according to claim 11, wherein:
the method further comprises controlling a phase shifter element by using: at least one detection signal of the detector and/or the sensor signal and/or a signal of the at least one light source, and/or
he light is emitted as pulsed light or as continuous light in the sending step.

13. A control unit configured to operate a sensor unit, the sensor unit including:
a waveguide coupled to a ring resonator via a coupling point,
a Mach-Zehnder interferometer, an input of the Mach-Zehnder interferometer being coupled to the waveguide, the Mach-Zehnder interferometer further including at least one output, and
a detection unit, which includes at least one detector configured to detect states present or output at the at least one output;
the control unit configured to:
send light into at least the waveguide; and
evaluate a reception light received by at least the detector, to obtain a sensor signal.

14. A non-transitory machine-readable storage medium on which is stored a computer program for operating a sensor unit, the sensor unit including:
a waveguide coupled to a ring resonator via a coupling point,
a Mach-Zehnder interferometer, an input of the Mach-Zehnder interferometer being coupled to the waveguide, the Mach-Zehnder interferometer further including at least one output, and
a detection unit, which includes at least one detector configured to detect states present or output at the at least one output;
the computer program, when executed by a control unit, causing the control unit to perform the following steps:
sending light into at least the waveguide; and
evaluating a reception light received by at least the detector, to obtain a sensor signal.
